(19) United States
(12) Patent Application Publication
(10) Pub. No.: US 2026/0225306 A1
(43) Pub. Date: Aug. 6, 2026

(54) Folding apparatus and folding method for folding a flap arrangement of a capsule

(71) Applicant: SACMI COOPERATIVA MECCANICI IMOLA SOCIETA’ COOPERATIVA, Imola (BO) (IT)

(72) Inventor: Matteo VENTURINI, Imola (BO) (IT)

(21) Appl. No.: 19/150,457

(22) PCT Filed: Jan. 23, 2024
(86) PCT No.: PCT/IB2024/050642

§ 371 Date: Jul. 23, 2025

(30) Foreign Application Priority Data
Jan. 25, 2023 (IT) 102023000001077

(51) Int. Cl. B29C 53/08; B29L 31/56; B65D 41/34

(52) U.S. Cl. CPC B29C 53/086; B29L 2031/565; B65D 41/3428

(57) ABSTRACT

An apparatus and a method for folding a flap arrangement of a capsule and a combination of capsule and a folding apparatus are disclosed; in which the capsule includes: a cup body defined by a side wall and by an end wall that bounds, at one end, the side wall; a tamper-evident band connected to the side wall by connecting elements and having an edge from which the flap arrangement leads; and an outer protrusion extending laterally outside the capsule; the folding method including the steps of:
arranging the capsule resting on a support element of a folding apparatus with one end facing upwards;
moving a punch element of the folding apparatus along a centring direction towards the support element and inserting the punch element inside the cup body until a centring element of the punch element interacts with clearance, in particular a radial clearance <0.30 mm, with inner portions of the capsule so as to block, or limit, a movement of the capsule along a plane perpendicular to the centring direction;
moving the support element along an operating direction having at least one component parallel to and opposite the centring direction, moving the support element along the operating direction including dragging the capsule and the punch element along the operating direction;
during moving the support element along the operating direction, making the flap arrangement interact with an abutting arrangement of the folding apparatus to rotate the flap arrangement from an initial configuration extending outwardly the cup body to an end configuration folded inwardly the cup body;
   which, when the centring element interacts with the inner portions of the capsule, a main of the capsule and a longitudinal axis of the abutting arrangement coincide so that the support element induces the capsule to interact with the abutting arrangement in a centred position with respect to the abutting arrangement in which the outer protrusion remains spaced apart from the abutting arrangement.

### BACKGROUND OF THE INVENTION

The invention relates to a folding apparatus and a folding method for folding a flap arrangement of a capsule, or closure, for example made of plastics, of the type used for closing containers like, for example, bottles. In particular, the invention relates to an apparatus and a method for folding the flap arrangement from an initial extended configuration in which this flap arrangement projects towards the outside a body of the capsule to a folded end configuration in which this flap arrangement projects inside the body of the capsule, in which this capsule is provided with an outer protrusion that extends laterally outside the capsule.

For example, the capsule is a so-called tethered capsule, i.e. a capsule that remains attached to the container even after being opened by connecting elements, which are also known as tethers or strips, which connect portions of a tamper-evident band or ring to different portions of the capsule, for example to portions of a side wall of the capsule, and thus enable the capsule to be retained on the tamper-evident band even after the container has been opened.

The invention also relates to a combination of a capsule and a folding apparatus for folding a flap arrangement of the capsule.

In the prior art, the capsules including a tamper-evident band provided with a flap arrangement that leads away from an edge thereof are generally formed, in particular by compression or injection moulding, in a forming apparatus. Leaving the forming apparatus, the flap arrangement of the capsule has an initial configuration extending outwardly in which the flap arrangement projects outside a body of the capsule. Before the capsule is associated with a container, the flap arrangement of the capsule has to be taken from the initial extended configuration to an end configuration folded inwardly in which the flap arrangement extends inside the body of the capsule and is folded inside the tamper-evident band with respect to the initial extended configuration such that the flap arrangement can interact with a ridge obtained on a neck of the container.

In order to take the flap arrangement from the initial extended configuration to the folded end configuration, folding apparatuses are known in the prior art including an abutting arrangement configured to abut on the flap arrangement and cause a rotation thereof around a deformable zone of the capsule that connects the tamper-evident band to the flap arrangement and acts as a hinge made of plastics to obtain the folded end configuration.

The abutting arrangement includes an outer sleeve including an abutting surface arranged for abutting on a portion of an edge of the capsule and is shaped to cooperate with the flap arrangement to permit a first partial rotation of the flap arrangement from the initial configuration extending outwardly to an intermediate configuration in which the flap arrangement is rotated partially towards a main axis of the capsule.

The abutting arrangement further includes an inner sleeve that is coaxial with the outer sleeve and arranged nearer a longitudinal axis of the abutting arrangement than the outer sleeve, provided with a further abutting surface against which a flap arrangement is taken to interact to terminate the rotation and reach the folded end configuration in which the flap arrangement is folded inside the tamper-evident band. This folded end configuration is the configuration that the flap arrangement has to have before associating the capsule with the neck of the container.

Known folding apparatuses further include a support element that is movable along an operating direction to take the capsule to interact with the abutting arrangement and obtain the end configuration folded towards the inside of the flap arrangement. In particular, the capsule, moved by the support element towards the abutting arrangement, is taken to interact first with the abutting surface of the outer sleeve and, subsequently, with the further abutting surface of the inner sleeve.

In order to move the capsule away from the abutting arrangement and maintain the capsule resting on a support surface of the support element, known folding apparatuses further include a punch element of substantially cylindrical shape that extends longitudinally around, in particular coaxially with, the longitudinal axis and is configured to interact with an inner portion of a top wall of the capsule and such that an outer portion of the top wall, opposite the inner portion, remains abutting on the support surface.

EP 1243520 A1 discloses a process for producing a closure cap that includes carrying out a folding operation immediately before or after a cutting operation on a rotating tower. The holding back section of a guarantee ring of the closure cap is folded over against the floor of the closure cap. A cutting unit is used to form a threshold breakage line along the closure cap, so the guarantee ring can be separated. The folding operation is carried out on one side and the cutting operation on the other, at two different levels. The cutting operation is carried out in two stages. In the first stage, the wall of the closure cap is weakened, and cuts are made in a second stage. The folding unit includes a ring element with a conical outer surface.

One drawback of prior art folding apparatuses is that a large number of capsules are rejected due to unsuitable folding of the flap arrangement. These rejects, which are also known as “folding rejects”, can even reach 20% of the capsules subjected to folding in the folding apparatus. A large number of rejects is detected, in particular, when the capsules of tethered type that are provided with a tamper-evident band with a flap arrangement and with an outer protrusion that extends from an outer side surface of the capsule to the outside of the body of the capsule are subjected to folding. This outer side surface can belong to the tamper-evident band and/or to the side wall of the body of the capsule. This outer protrusion causes that the capsule is not axisymmetric.

As each capsule is supplied to a respective support element with a non-predefined angular orientation, a capsule is frequently taken to abut on an abutting arrangement of known folding apparatuses in a position having phasing with respect to the abutting arrangement that is not known. As a result, the capsule may come to abut on the abutting portion with parts that are different from the edge thereof, for example with a portion of top outer surface of the protrusion. This entails unsuitable folding of the flap arrangement and damage to the capsule because of the fact that the support element pushes the outer protrusion against the abutting arrangement, the outer protrusion having an extended part protruding which is suspended and not supported by parts of the capsule and thus easily foldable if subjected to a thrust force acting thereupon. As a result, the damaged capsule has to be rejected.

### SUMMARY OF THE INVENTION

One object of the invention is to improve folding apparatuses and folding methods of known type.

A further object of the invention is to provide a folding apparatus and a folding method that are able to overcome drawbacks or disadvantages of the prior art.

One further object of the invention is to provide an apparatus and a method for folding a flap arrangement of a capsule that assure correct positioning of the capsule with respect to an abutting arrangement arranged for cooperating in folding the flap arrangement.

Still another object is to provide an apparatus and a method for folding a flap arrangement of non-axisymmetric capsules having an irregular outer profile, in particular tethered capsules provided with an outer protrusion.

Such objects are achieved by the folding apparatus and by the folding method according to one or more of the claims set out below.

The folding apparatus according to the invention includes an abutting arrangement arranged for cooperating in folding a flap arrangement of a capsule and a punch element that is coaxial with the abutting arrangement and provided with an enlarged centring portion configured to engage inner portions of a body of a capsule to connect the capsule to the punch element and ensure that the capsule is moved towards the abutting arrangement in a centred position with respect to the abutting arrangement, i.e. in such a manner that a main axis of the capsule coincides with a longitudinal axis of the abutting arrangement.

Owing to the invention, it is possible to obtain an apparatus and a method for folding a flap arrangement of non-axisymmetric capsules provided with an outer protrusion that permits precise centring of the capsule with respect to the abutting arrangement.

Owing to the invention, it is thus possible to perform correct folding of the flap arrangement even in non-axisymmetric capsules provided with an outer protrusion.

Accordingly, owing to the invention, it is thus possible to reduce rejects from the production of capsules provided with an outer protrusion.

In one embodiment, a folding method is provided for folding a flap arrangement of a capsule, in which the capsule includes: a cup body defined by a side wall and by an end wall that bounds, at one end, the side wall; a tamper-evident band connected to the side wall by connecting elements and having an edge from which the flap arrangement leads; and an outer protrusion extending laterally outside the capsule.

The folding method includes the steps of:
arranging the capsule resting on a support element of a folding apparatus with one end facing upwards;
moving a punch element of the folding apparatus along a centring direction towards the support element and inserting the punch element inside the cup body until a centring element of the punch element interacts with clearance, in particular a radial clearance <0.30 mm, with inner portions of the capsule so as to block, or limit, a movement of the capsule along a plane perpendicular to the centring direction;
moving the support element along an operating direction having at least one component parallel to and opposite the centring direction, moving the support element along the operating direction including dragging the capsule and the punch element along the operating direction;
during moving the support element along the operating direction, making the flap arrangement interact with an abutting arrangement of the folding apparatus to rotate the flap arrangement from an initial configuration extending outwardly the cup body to an end configuration folded inwardly the cup body;
   in which, when the centring element interacts with the inner portions of the capsule, a main axis of the capsule and a longitudinal axis of the abutting arrangement coincide so that the support element induces the capsule to interact with the abutting arrangement in a centred position with respect to the abutting arrangement in which the outer protrusion remains spaced apart from the abutting arrangement.

In one embodiment, a folding apparatus of a flap arrangement of a capsule is provided, in which the capsule includes: a cup body defined by a side wall and by an end wall that bounds, at one end, the side wall; a tamper-evident band connected to the side wall by connecting elements and having an edge from which the flap arrangement leads; and an outer protrusion extending laterally outside the capsule.

The folding apparatus includes:
a support element arranged for restingly receiving and supporting the capsule with one end facing upwards, the support element being movable along an operating direction;
a punch element configured to be inserted inside the cup body and movable along a centring direction having at least one component parallel to and opposite the operating direction, the punch element being provided with a centring element arranged for interacting with clearance, in particular a radial clearance <0.30 mm or <0.15 mm or <0.05mm, with inner portions of the capsule when said punch element is inserted inside the cup body so as to block, or limit, a movement of the capsule along a plane perpendicular to the centring direction;
an abutting arrangement configured to interact with the flap arrangement to rotate the flap arrangement from an initial configuration extending outwardly the cup body to an end configuration folded inwardly the cup body;
   in which, when the centring element interacts with the inner portions of the capsule, a main axis of the capsule and a longitudinal axis of the abutting arrangement coincide so that the support element can drag the capsule along the operating direction in a centred position of the capsule with respect to the abutting arrangement in which the outer protrusion remains spaced apart from the abutting arrangement.

In one embodiment, a combination of a capsule and of a folding apparatus for folding a flap arrangement of the capsule is provided. The capsule further includes:
a cup body defined by a side wall and by an end wall that bounds, at one end, the side wall;
a tamper-evident band connected to the side wall by connecting elements and having an edge from which the flap arrangement leads; and
an outer protrusion extending laterally outside the capsule.

The folding apparatus for folding a flap arrangement of the capsule includes:
a support element arranged for restingly receiving and supporting the capsule with one end facing upwards, the support element being movable along an operating direction;
a punch element configured to be inserted inside the cup body and movable along a centring direction having at least one component parallel to and opposite the operating direction, the punch element being provided with a centring element arranged for interacting with clearance, in particular a radial clearance <0.30 mm or <0.15 mm or <0.05mm, with inner portions of the capsule when said punch element is inserted inside the cup body so as to block, or limit, a movement of the capsule along a plane perpendicular to the centring direction;
an abutting arrangement configured to interact with the flap arrangement to rotate the flap arrangement from an initial configuration extending outwardly the cup body to an end configuration folded inwardly the cup body;
   in which, when the centring element interacts with the inner portions of the capsule, a main axis of the capsule and a longitudinal axis of the abutting arrangement coincide so that the support element can drag the capsule along the operating direction in a centred position of the capsule with respect to the abutting arrangement in which the outer protrusion remains spaced apart from the abutting arrangement.

### BRIEF DESCRIPTION OF THE DRAWINGS

The invention can be better understood and implemented with reference to the enclosed drawings that illustrate some embodiments thereof by way of non-limiting example, in which:

FIG. 1 is an axial section of a folding apparatus for folding a flap arrangement of a capsule according to a first embodiment;

FIG. 2 is an axial section of a folding apparatus for folding a flap arrangement of a capsule according to a second embodiment;

FIG. 3 is an axial section of a folding apparatus for folding a flap arrangement of a capsule according to a third embodiment;

FIG. 4 is an enlarged detail of FIG. 1;

FIG. 5 is an enlarged detail of FIG. 2;

FIG. 6 is an enlarged detail of FIG. 3;

FIG. 7 is another enlarged detail of FIGS. 1, 2 and 3;

FIG. 8 is a perspective view of a centring element with which the folding apparatus of FIG. 1 is provided;

FIG. 9 is a perspective view of a capsule arranged with an open end facing downwards provided with a flap arrangement that can be folded by one of the folding apparatuses according to the invention;

FIG. 10 is an axial section of the capsule di FIG. 9 arranged with an open end facing downwards and with the flap arrangement in an initial extended configuration extending towards the outside of a cup body of the capsule;

FIG. 11 is an axial section of the capsule di FIG. 9 arranged with an open end facing downwards and with the flap arrangement in an end configuration folded towards the inside of the cup body of the capsule.

### DETAILED DESCRIPTION

For the sake of simplicity of exposure, similar elements of different embodiments will be indicated below by the same reference numbers.

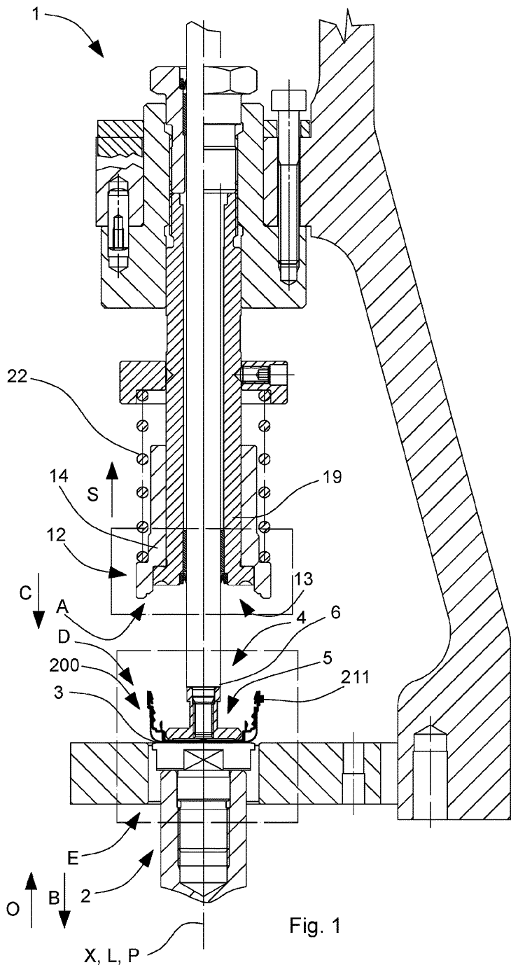

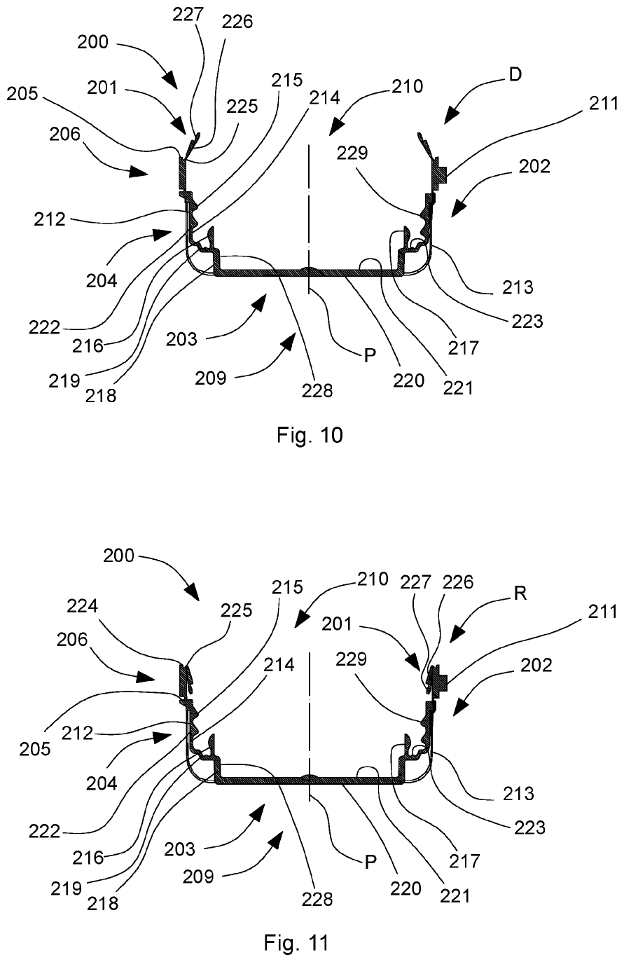

In FIGS. 1 to 3, three embodiments are shown of a folding apparatus that are identified by the reference numbers 1, 100 and 1000 respectively. The folding apparatus 1, 100 and 1000 is arranged for perform a folding operation on a capsule, or closure, 200, in particular is arranged for folding a flap arrangement 201 with which the capsule 200 is provided from an initial extended configuration D thereof (shown in particular in FIG. 10) outwardly a cup body 202 of the capsule 200 to a folded end configuration R thereof (shown in particular in FIG. 11) inwardly the cup body 202 of the capsule 200.

In the folding apparatus 1, 100 and 1000, it is possible to perform the folding operation of folding the capsule 200 which, for example, can be shaped as disclosed below.

With reference in particular to FIGS. 9 to 11, the capsule 200 is made, for example, of plastics and is of the type used to close containers, like for example bottles.

The capsule 200 can be formed, in particular by compression or injection moulding, in a forming apparatus, for example in a respective forming mould of the forming apparatus.

The cup body 202 of the capsule 200 includes an end wall 203 of substantially circular shape and a side wall 204, for example a substantially cylindrical wall, which extends from the perimeter of the end wall 203 to an end edge 205 thereof.

The cup body 202 is thus defined by the side wall 204 and by the end wall 203.

The end wall 203 is provided with an outer end surface 220 facing the outside of the cup body 202 and with an inner end surface 221, opposite the outer end surface 220 and facing the inside of the cup body 202.

The outer end surface 220 extends on a plane substantially perpendicular to a main axis P of the capsule 200.

The capsule 200 further includes a tamper-evident band, or safety ring 206 of substantially annular shape that is suitable for informing a user about the integrity of a product packaged in the container.

The tamper-evident band 206 is associated with the end edge 205 of the cup body 202 opposite the end wall 203.

The capsule 200 can further include connecting elements 207 arranged for connecting portions of the side wall 204 to portions of the tamper-evident band 206.

The connecting elements 207 can include, in particular, bridge elements or bridges, i.e. elements of plastics intended to be fractured by a user during a first opening of the container to which the capsule 200 is applied to show evidence of tampering with the closure of the container, and/or at least one tether element 208 which, on the other hand, enables the capsule 200 to be retained in the tamper-evident band 206 thereof even after the container has been opened.

The capsule 200 is, in particular, a so-called tethered capsule, i.e. a capsule that remains attached to the container even after opening thereof by means of one or more of the tether elements 208, which connect portions of the tamper-evident band 206 to different portions of the capsule 200, for example to portions of a side wall 204 of the capsule 200 and thus enable a capsule 200 to be retained on the tamper-evident band 206 thereof even after the container has been opened.

Between the cup body 202 and the tamper-evident band 206, an intended separating line is defined that can include a plurality of cuts or of openings separated by the connecting elements 207.

The side wall 204 is provided with a closed end 209 arranged at the end wall 203 and with an open end 210 arranged at the tamper-evident band 206. The end wall 203 bounds at one end, in particular at the closed end 210, the side wall 204.

The capsule 200 further includes an outer protrusion 211 that extends laterally outside the capsule 200. The outer protrusion 211 causes the capsule 200 not to be axisymmetric.

The outer protrusion 211 extends, in particular, starting from an outer surface of the capsule 200 to the outside of the capsule 200.

The protrusion 211 is suitable to ease the lock the capsule 200 in an open position on the container once it is opened.

In the embodiment shown in the Figures, the outer protrusion 211 extends starting from an outer surface of the tamper-evident band 206.

The side wall 204 includes an outer side surface 212 that can be provided with a plurality of knurling lines 213 designed to promote gripping of the capsule 200 by a user to tighten it on the container or untighten it therefrom or by a capping machine that applies the capsule 200 to the container to be closed.

The side wall 202 further includes an inner side surface 214 on which an inner thread 215 is obtained that is designed to engage an outer thread of the container.

The capsule 200 can further include a seal element 216 that enables the product contained in the container to be isolated from the outer environment.

The seal element 216 can have a substantially annular shape.

The seal element 216 includes an inner seal surface 217 facing the inside of the capsule 200, i.e. towards the main axis P of the capsule 200.

The side wall 204 can include a first annular portion 218 of substantially annular shape that leads away from the perimeter of the end wall 203 and extends along a direction parallel to the main axis P.

The side wall 204 can further include a second portion 219 that widens radially with respect to the first annular portion 218 away from the main axis P and is connected on one side to an edge of the first annular portion 218.

The side wall 204 can further include a third annular portion 222 of substantially annular shape that leads away from an edge of the second portion 219 and extends along a direction parallel to the main axis P.

The seal element 216 can project from an inner surface area 223 of the second portion 219. The inner surface area 223 is a surface area of the second portion 219 facing the inside of the cup body 202.

In one embodiment that is not illustrated, the seal element 216 projects from the inner end surface 221 of the end wall 203.

The flap arrangement 201 is provided in the tamper-evident band 206. In particular, the flap arrangement 201 projects from a portion of an edge 224 of the tamper-evident band 206.

The tamper-evident band 206 includes a deformable zone 225, connected to the edge 224, that acts as a plastic hinge that is suitable for connecting the flap arrangement 201 to the tamper-evident band 206.

The flap arrangement 201 in use, i.e. when it is arranged in the folded end configuration R, is suitable to interact with an annular ridge of the container to retain the tamper-evident band 206 axially. In other words, the flap arrangement 201 acts to prevent the tamper-evident band 206 from moving parallel to the main axis P when the capsule 200 is loosened from the port during the first opening of the container, and thus promotes the breakage of the connecting elements 207 thus enabling the tamper-evident band 206 to be separated from the cup body 202 or to remain linked to one or more tether elements 208 in the case of capsules 200 of tethered type.

The flap arrangement 201 can include a first part 226 having one circumferential end connected to the deformable zone 225 and a second part 227 connected to the first part 226.

The first part 226 and the second part 227 can include an annular panel or a plurality of flaps.

Leaving the forming apparatus, the flap arrangement 201 has the initial extended configuration D outwardly in which the flap arrangement 201 projects outside the cup body 202 of the capsule 200. Before the capsule is associated with the container, the flap arrangement 201 of the capsule 200 has to be moved from the initial extended configuration D to the end configuration R folded inwardly in which the flap arrangement 201 projects inwardly the cup body 202 of the capsule 200 and is, in particular, folded inside the tamper-evident band 206 so that the flap arrangement 201 can interact in use with the ridge obtained on the container.

The folding operation is conducted, for example, by means of the folding apparatus 1, 100, 1000 according to the invention.

A description of the folding apparatus 1 will be given below. For the folding apparatus 100 and the folding apparatus 1000 thereof, the differences thereof from the folding apparatus 1 will be highlighted whereas the description of elements that are identical in shape and/or function will not be repeated.

In FIGS. 1, 2 and 3 relating to three embodiments of the folding apparatus according to the invention, the capsule 200 is shown at the end of the folding operation with the flap arrangement 201 arranged in the folded end configuration R.

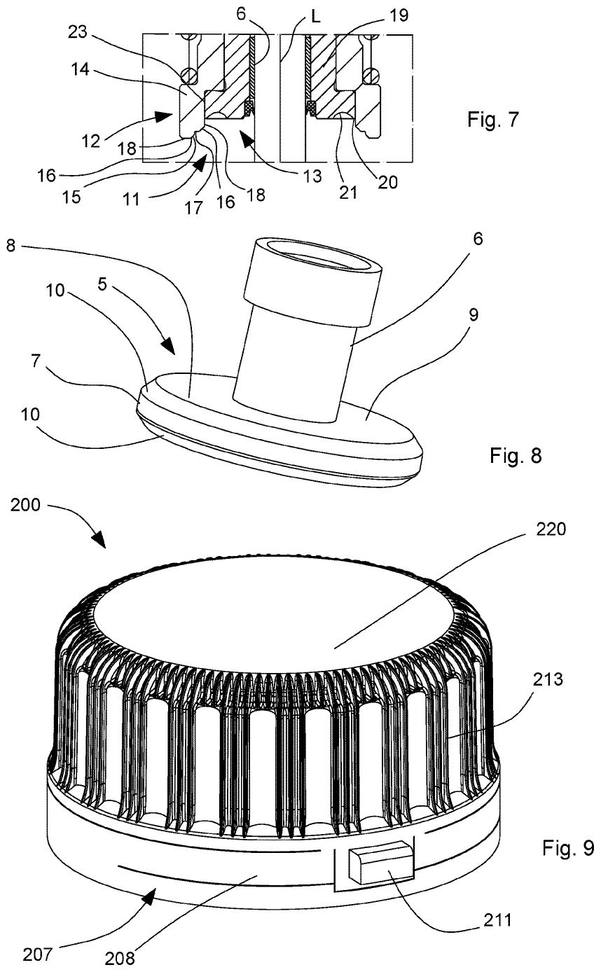

With reference in particular to FIGS. 1, 4 and 7, the folding apparatus 1 includes a support element 2 arranged for restingly receiving and supporting the capsule 200 arranged with the open end 210 facing upwards.

The support element 2 includes a rest surface 3 intended for contacting the outer end surface 220 when the capsule 200 is arranged on the support element 2 to be subjected to the folding operation.

The support element 2 is movable, in particular axially, along an operating direction O to enable the capsule 200 to be taken to undergo the folding operation. The operating direction O is directed, in particular, upwards, i.e. away from the outer end surface 220. The operating direction O is, in particular, vertical.

The support element 2 thus supports the capsule 200 during the axial movement along the operating direction O.

The operating direction O is parallel to an axis X of the folding apparatus 1.

The folding apparatus 1 further includes a punch element 4 configured to be inserted inside the cup body 202 and movable, in particular axially, along a centring direction C having at least one component parallel to and opposite the operating direction O. The centring direction C is, in particular, vertical.

The punch element 4 is provided with a centring element 5 arranged for interacting with clearance with inner portions of the capsule 200 when the punch element 4 is inserted inside the cup body 202 so as to block, or limit, a movement of the capsule 200 along a plane perpendicular to the centring direction C.

The clearance is, in particular, a radial clearance <0.30 mm.

The clearance can include a radial clearance <0.15 mm, in particular <0.05 mm.

The centring element 5 is thus arranged for guiding the capsules 200 during the axial movement of the capsule 200 in particular along the centring direction C.

The punch element 4 is further provided with a stem 6 that, in particular, is arranged coaxially with the axis X.

Also the centring element 5 is, in particular, arranged coaxially with the axis X.

Radial clearance means clearance measured along a direction substantially perpendicular to the axis X.

The centring element 5 includes a body 8 that can be substantially disc or cylinder-shaped.

The body 8 of the centring element 5 is so sized that at least one portion of a circumferential perimeter area 7 thereof can interact with inner portions of the capsule 200.

The clearance is defined between the centring element 5 and the capsule 200. In particular, the clearance is defined between the circumferential perimeter area 7 of the centring element 5 and the inner portions of the capsule 200.

The circumferential perimeter area 7 can have, in particular, an annular shape.

The centring element 5 has, in particular, a cross section, taken along a section perpendicular to the axis X, greater than the cross section of the stem 6, taken along a section perpendicular to the axis X.

The body 8 can further include a pair of opposite faces including an upper face 9 and a lower face, opposite the upper face 9 and facing the rest surface 3 of the support element 2. Each of these opposite faces can connect to the circumferential perimeter area 7 by a respective connecting zone 10 that can be in particular chamfered.

The centring element 5 can be fitted to the stem 6. In particular, in one embodiment, the centring element 5 and the stem 6 can be formed as a single body.

The inner portions of the capsule 200 with which the body 8 and, in particular, the circumferential perimeter area 7, can interact can include: at least one portion of an inner surface 228 of the first annular portion 218 (i.e. a surface of the first annular portion 218 facing the inside of the cup body 202), and/or at least one portion of the inner seal surface 217 of the seal element 216 and/or at least one surface portion 229 of the inner thread 215.

With reference in particular to the example of FIG. 1, the centring element 5 is fitted at one end of the stem 6 and is shaped to interact, in use, i.e. when the punch element 4 is inserted into the cup body 202, with a portion of the surface 217 of the first annular portion 218.

Further, in use, the lower face of the centring element 5 is intended to come into axial contact with at least one portion of the inner end surface 221 of the capsule 200. In other words, in addition to the aforesaid inner portions, the body 8, in use, interacts with the capsule 200 also with the lower face of the body 8 of the centring element 5.

In other words, in use, the centring element 5 is inserted into the cup body 202 until a face of the centring element 5, in particular the lower face, contacts the inner end surface 221 of the capsule 200.

The folding apparatus 1 further includes an abutting arrangement 11 configured to interact with the flap arrangement 201 to rotate the flap arrangement 201 from the initial extended configuration D outwardly the cup body 202 to the end configuration R folded inwardly the cup body 202.

The abutting arrangement 11 has a longitudinal axis L coinciding with the axis X of the folding apparatus 1.

The support element 2 is movable, axially, to approach, and move away from, the abutting arrangement 11. In FIGS. 1 to 6, the support element 2 is shown in a spaced apart position E, in which the support element 2 is spaced apart from the abutting arrangement 11 and does not interact therewith.

In use, when the support element 2 moves the capsule 200 axially along the operating direction O to induce the flap arrangement 201 to interact with the abutting arrangement 11, the support element 2 also moves the punch element 4 along the same direction with the centring element 5 that is inserted into the cup body 202 and has the circumferential perimeter area 7 coupled with clearance with inner portions of the capsule 200.

When the centring element 5 interacts with inner portions of the capsule 200, the main axis P of the capsule 200 and the longitudinal axis L of the abutting arrangement 11 coincide so that said support element 2 can drag the capsule 200 along the operating direction O in a centred position of the capsule 200 with respect to the abutting arrangement 11 in which the outer protrusion 211 remains spaced apart from the abutting arrangement 11. In this manner, the protrusion 211, or other unsuitable parts, will not interact with the abutting arrangement 11 which therefore will not damage the capsule 200 when the capsule 200 is taken by the support element 2 to abut thereupon.

Owing to the provision of the centring element 5 that makes the capsule 200 have the main axis P coincide with the longitudinal axis L of the abutting arrangement 11 and maintains this coincidence during the axial movement of the capsule 200 along the operating direction O, the capsule 200 is made to interact with the abutting arrangement 11 in a centred position that permits a correct folding of the flap arrangement 201 even in non-axisymmetric capsules 200 provided by the outer protrusion 211 because the outer protrusion 211 remains spaced apart from the abutting arrangement 11 during the folding operation and does not interact with the abutting arrangement 11.

Accordingly, owing to the provision of the centring element 5 it is thus possible to reduce rejects from the production of capsules with an outer protrusion.

The abutting arrangement 11 includes a first abutting element 12 and second abutting element 13 configured to interact with the flap arrangement 201 and cause rotation thereof around the deformable zone 225 of the capsule 200.

In particular, in use, while the capsule 200 is moved along the operating direction O, the flap arrangement 201 interacts first with the first abutting element 12 and, subsequently, with the second abutting element 13.

The first abutting element 12 and the second abutting element 13 are movable axially in relation to one another.

In particular, in the embodiments illustrated in the Figures, the first abutting element 12 is movable axially and the second abutting element 13 is fixed.

In use, the first abutting element 12 is moved along a direction, in particular an ascent direction S, having a component parallel to and concordant with the operating direction O, under the thrust of the capsule 200 when it is taken to abut on the first abutting element 12. The ascent direction S is, in particular, vertical.

The first abutting element 12 can include an outer sleeve 14 including an abutting surface 15 arranged for abutting on the flap arrangement 201.

The abutting surface 15 includes at least one portion of tilted surface 16 shaped to cooperate with the flap arrangement 201 to permit a first partial rotation of the flap arrangement 201 from the initial extended configuration D outwardly to an intermediate configuration in which the flap arrangement 201 is rotated partially towards the main axis P—and to the longitudinal axis L—of the capsule 200.

The abutting surface 15 can further include a step portion 17 shaped to receive abuttingly a portion of the edge 224 of the tamper-evident band 206.

In use, in fact, the capsule 200 is moved by the support element 2 along the operating direction O and when the flap arrangement 201 abuts on a portion of tilted surface 16 it is partially rotated. While the capsule 200 continues to be moved axially, a portion of the edge 224 then comes to abut on the abutting surface 15. At this point, the flap arrangement 201 has reached the intermediate configuration.

The step portion 17 can be, in particular, interposed between two tilted surface portions 16, each of the tilted surface portions 16 connecting a part of the step portion 17 with an outer face 18 of the outer sleeve 14 and cooperating to rotate the flap arrangement 201 in the intermediate configuration.

The second abutting element 13 can include an inner sleeve 19 that is coaxial with the outer sleeve 14 and arranged nearer the longitudinal axis L with respect to the outer sleeve 14.

The inner sleeve 19 is provided with a further abutting surface 20 arranged for further abutting on the flap arrangement 201 and shaped to cooperate with the flap arrangement 201 to permit a further rotation of the flap arrangement 201 from the intermediate configuration to the end configuration R folded inwardly.

The further abutting surface 20 is arranged, in particular, at a greater height than the abutting surface 15.

The further abutting surface 20 can include a re-entrant curve portion 21 shaped to facilitate the progressive rotation of the flap arrangement 201 from the intermediate configuration to the end configuration R folded inwardly.

The abutting arrangement 11 can further include an elastic arrangement 22 associated, for example, with the first abutting element 12 to urge constantly the first abutting element 12 to a rest position A in which the first abutting element 12 is located when the capsule 200 does not interact therewith.

The elastic arrangement 22 can include, in particular, an elastic element, like for example a spring.

After the edge 224 has come to abut on the step portion 17, the support element 2 continues to be moved along the operating direction O thus pushing the capsule 200 against the first abutting element 12 causing an axial movement thereof along the operating direction O against the action of the elastic arrangement 22.

The flap arrangement 201 in the intermediate configuration thus comes to interact with the further abutting surface 20. The angular orientation of the flap arrangement 201 in the intermediate configuration and the shape of the re-entrant curved portion 21 are such as to promote progressive rotation of the flap arrangement 201 from the intermediate configuration to the end configuration R folded inwardly.

The stroke of the support element 2 along the operating direction O ends when the flap arrangement 201 of the capsule 200 is in the end configuration R folded inwardly of the cup body 202. In the stroke end position of the support element 2 along the operating direction O, the flap arrangement 201 abuts on a portion of a side surface 23 of the inner sleeve 19.

In order to move the capsule 200 away from the second abutting element 13, the punch element 4 is again driven to move along the centring direction C. In this manner, the centring element 5, which is coupled with clearance with inner portions of the capsule 200, exerts a thrust action on the inner portions of the capsule 200 with which it is in contact and also the capsule 200 is accordingly moved along the centring direction C. In particular, in the embodiment of FIG. 1 it is the lower face of the centring element 5 which is in axial contact on the inner end surface 221 of the capsule 200, which exerts the thrust on the capsule 200 and causes the shift thereof along the centring direction C.

The centring element 5 thus also guides the capsule 200 during the axial movement of the capsule 200 along the centring direction C.

The support element 2, in particular at the same time as the movement of the punch element 4 along the centring direction, is driven to move along a direction having at least one component parallel to and concordant with the centring direction C, in particular along a descent direction B. The descent direction B is, in particular, vertical.

The support element 2 thus supports (and abuts on) the capsule 200 even during the axial movement along the descent direction B.

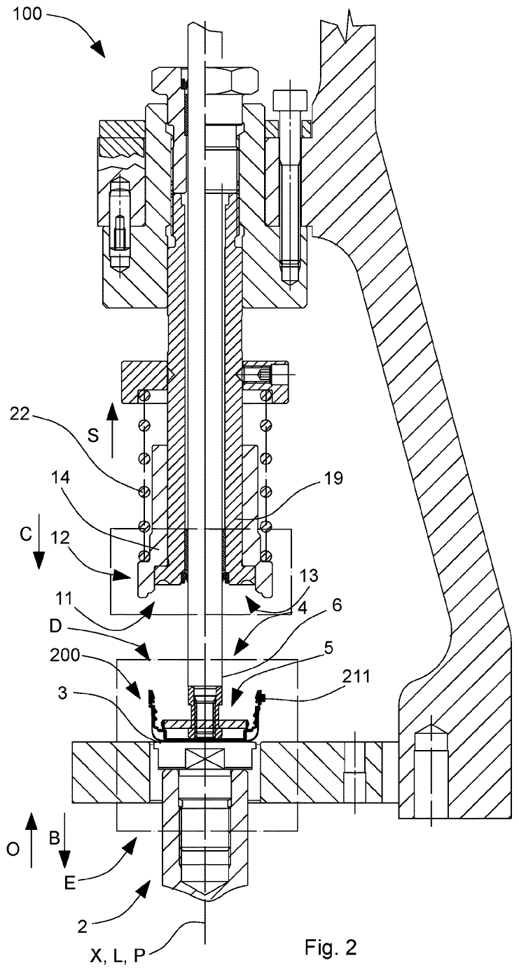

The folding apparatus 100 of FIGS. 2 and 5 differs from the folding apparatus 1 through the fact that the centring element 5 is fitted at a set distance from a free end 24 of the stem 6 and is shaped to interact, in use, i.e. when the punch element 4 is inserted into the cup body 202, with a portion of the inner seal surface 217 of the seal element 216.

The free end 24 of the stem 6 is designed, in use, to come into axial contact with the capsule 200. In other words, in use, the centring element 5 of the folding apparatus 100 is inserted into the cup body 202 until the free end 24 of the stem 6 contacts the inner end surface 221 of the capsule 200.

When the capsule 200 has to be moved away from the second abutting element 13 after the flap arrangement 201 has been taken to the folded end configuration R, the punch element 4 is again driven to move along the centring direction C. In this manner, the centring element 5, which is coupled with clearance with inner portions of the capsule 200, exerts a thrust action on the inner portions of the capsule 200 with which it is in contact and the capsule 200 is accordingly also moved along the centring direction C. In particular, in the embodiment of FIG. 2 it is the free end 24 of the centring element 5 that exerts the thrust on the inner end surface 221 of the capsule 200 and causes movement thereof along the centring direction C.

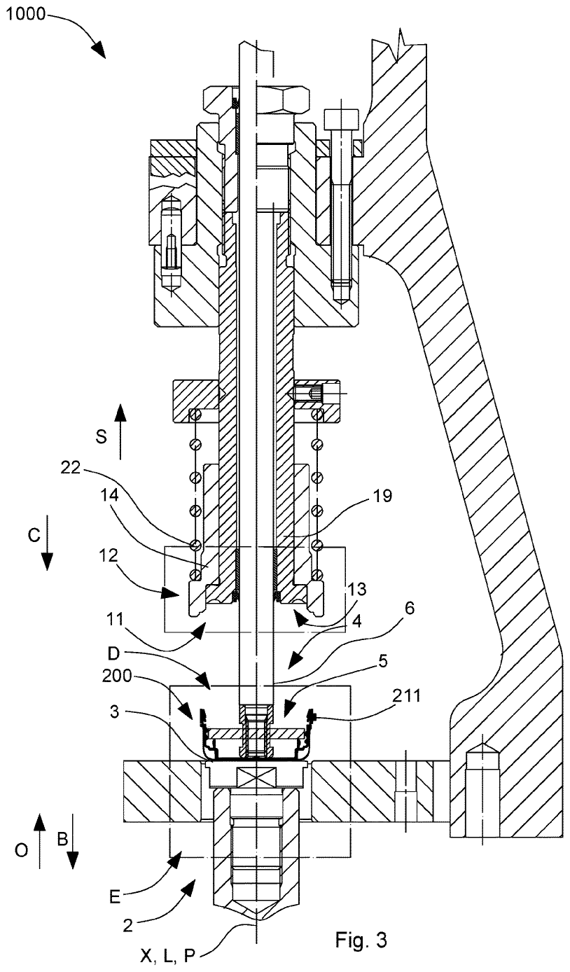

The folding apparatus 1000 of FIGS. 3 and 6 differs from the folding apparatus 100 through the fact that the centring element 5 is fitted at a set distance from the free end 24 of the stem 6, this set distance being greater than the distance in the punch element 4 of the folding apparatus 100.

The centring element 5 of the folding apparatus 1000 is shaped to interact, in use, i.e. when the punch element 4 is inserted into the cup body 202, with a portion of the surface 229 of the inner thread 215.

When the capsule 200 has to be moved away from the second abutting element 13 after the flap arrangement 201 has been taken to the folded end configuration R, the punch element 4 is again driven to move along the centring direction C. In this manner, the centring element 5, which is coupled with clearance with inner portions of the capsule 200, exerts a thrust action on the inner portions of the capsule 200 with which it is in contact and the capsule 200 is accordingly also moved along the centring direction C. In particular, also in the embodiment of FIG. 3, it is the free end 24 of the centring element 5 that exerts the thrust on the inner end surface 221 of the capsule 200 and causes movement thereof along the centring direction C.

The folding apparatus 1, 100, 1000 as disclosed is suitable for implementing a folding method to be applied to the capsule 200.

The folding method includes arranging the capsule 200 resting on the support element 2 with the open end 210 facing upwards, i.e. in such a manner that the outer end surface 220 of the end wall 203 of the capsule 200 rests in contact with the rest surface 3 of the support element 2.

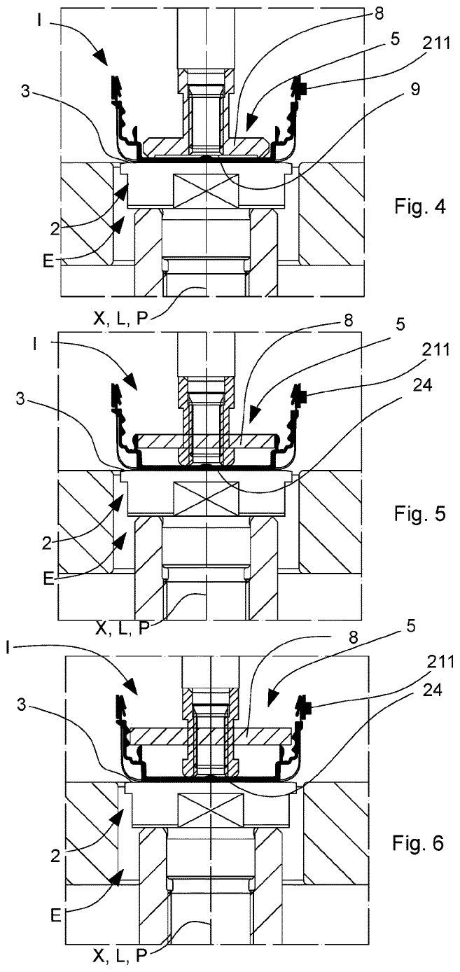

The method further includes the step of moving the punch element 4 along the centring direction C towards the support element 2 and inserting the punch element 4 inside the cup body 202 until the centring element 5 of the punch element 4 interacts with inner portions of the capsule 200 so as to block, or limit, a movement of the capsule 200 along a plane perpendicular to the centring direction C. In this manner, the centring element C is in a position of engagement I (shown, in particular, in FIGS. 4, 5, 6) with the capsule 200.

In the embodiment of FIG. 1 in the position of engagement I, the punch element 4 in particular contacts, by the centring element C, the inner surface 228 of the first annular portion 218 and the inner end surface 221 of the capsule 200.

In the embodiment of FIG. 2 in the position of engagement I, the punch element 4 in particular contacts, by the centring element 5, the inner seal surface 217 of the seal element 216 of the capsule 200 and, by the stem 6, the inner end surface 221 of the capsule 200.

In the embodiment of FIG. 3 in the position of engagement I, in particular the punch element 4 contacts, by the centring element 5, the surface 229 of the inner thread 215 of the capsule 200 and, by the stem 6, the inner end surface 221 of the capsule 200.

The method further includes the step of moving the support element 2 along the operating direction O having at least one component parallel to and opposite the centring direction C. The step of moving the support element 2 along the operating direction O includes dragging the capsule 200 and the punch element 4 along the operating direction O.

During the step of moving the support element 2 along the operating direction O, the method includes making the flap arrangement 201 interact with the abutting arrangement 11 to rotate the flap arrangement 201 from the initial extended configuration D to the outside of the cup body 202 to the end configuration R folded inwardly of the cup body 202, in which, when the centring element 5 interacts with the inner portions of the capsule 200, the main axis P of the capsule 200 and the longitudinal axis L of the abutting arrangement 11 coincide so that the support element 2 induces the capsule 200 to interact with the abutting arrangement 11 in a centred position with respect to the abutting arrangement 11, in which the outer protrusion 211 remains spaced apart from the abutting arrangement 11.

The step of inserting the punch element 4 inside the cup body 202 can include, in particular, moving laterally, i.e. along a direction substantially perpendicular to the centring direction C, a capsule 200 by the centring element 5 so as to make the main axis P coincide with the longitudinal axis L.

The step of moving the support element 2 along the operating direction O can include, in particular, the step of inducing the flap arrangement 201 to interact with at least one portion of tilted surface 16 of the abutting surface 15 of the first abutting element 12 of the abutting arrangement 11. The at least one portion of tilted surface 16 is shaped to cooperate with the flap arrangement 201 to permit a first partial rotation of the flap arrangement 201 from the initial extended configuration D outwardly to the intermediate configuration in which the flap arrangement 201 is rotated partially towards the main axis P of the capsule 200 and thus towards the longitudinal axis L of the abutting arrangement 11.

Subsequently to the step of inducing the flap arrangement 201 to interact with at least one portion of tilted surface 16, the method can include inducing a portion of the edge 224 of the tamper-evident band 206 to abut on the step portion 17 of the abutting surface 15.

The folding method, after the step of inducing a portion of an edge 224 of the tamper-evident band 206 to abut on the step portion 17, can include the step of continuing to move the support element 2 along the operating direction O and pushing the edge 224 on the step portion 17 to move the first abutting element 12 along a direction, in particular the ascent direction S, having a component parallel to and concordant with the operating direction O.

The step of continuing to move the support element 2 along the operating direction O can include the step of inducing the flap arrangement 201 to interact progressively with a plurality of parts of the further abutting surface 20 of the second abutting element 13 of the abutting arrangement 11. The further abutting surface 20 is shaped to cooperate with the flap arrangement 201 to take the flap arrangement 201 from the intermediate configuration to the end configuration R folded inwardly in which the flap arrangement 201 is folded inside the tamper-evident band 206.

The folding method can further include, after obtaining the end configuration R folded inwardly, moving again the punch element 4 along the centring direction C to move the capsule 200 away from the abutting arrangement 11.

The step of moving again the punch element 4 along the centring direction C can include simultaneously moving the support element 2 along a direction, in particular the descent direction B, having at least one component parallel to and concordant with the centring direction C. The step of moving again the punch element 4 along the centring direction C includes pushing the capsule 200 by the punch element 4 to abut on the rest surface 3 of the support element 2.

In particular, the punch element 4 can push the capsule 200 against the rest surface 3 of the support element 2 by the lower face of the centring element 5 or by the free end 24 of the stem 6.

The step of inserting the punch element 4 inside the cup body 202 can include the step of inducing a circumferential perimeter area 7 of the centring element 5 to interact with inner portions of the seal element 216 of the capsule 200, in particular with the inner seal surface 217, so as to block, or limit, a movement of the capsule along a plane perpendicular to the centring direction C.

The step of inserting the punch element 4 inside the cup body 202 can include inducing the circumferential perimeter area 7 of the centring element 5 to interact with inner portions of the first annular portion 218 of the capsule 200, in particular with the inner surface 228, so as to block, or limit, a movement of the capsule 200 along a plane perpendicular to the centring direction C.

The step of inserting the punch element 4 inside the cup body 202 can include inducing the circumferential perimeter area 7 of the centring element 5 to interact with inner portions of the inner thread 215 of the capsule 200, in particular with the surface 229 of the inner thread 215, so as to block, or limit, a movement of the capsule 200 along a plane perpendicular to the centring direction C.

In one example, there is provided the combination of a capsule 200 and of the folding apparatus 1, 100, 1000, in which the capsule 200 includes:
the flap arrangement 201 arranged to be folded by the folding apparatus 1, 100, 1000;
the cup body 202 which is defined by the side wall 204 and by the end wall 203 that bounds, at the end 209, the side wall 204;
the tamper-evident band 206 which is connected to the side wall 204 by means of the connecting elements 207 and which has the edge 224 from which the flap arrangement 201 leads; and
the outer protrusion 211 extending laterally outside the capsule 200.

As can be seen from what has been described above, the folding apparatus and the folding method according to the invention, as well as a combination according to the invention of a capsule and a folding apparatus according to the invention for folding a flap arrangement of the capsule, enable the limits and drawbacks of the apparatuses and methods of the prior art to be overcome, so as to successfully achieve the set objects.

The apparatus and the method according to the invention are particularly useful for folding the flap arrangement on a capsule that is provided, in particular, with an outer protrusion.

Owing to the invention, it is in fact possible to centre the capsule with respect to the abutting arrangement that cooperates with the capsule in folding the flap arrangement so that the outer protrusion remains spaced apart from the abutting arrangement, thus preventing the abutting arrangement from being able to exert a thrust action against the outer protrusion that may entail damage to the capsule.

Owing to the invention, it is thus possible to reduce rejects in the production of capsules provided with a tamper-evident band with a flap arrangement and with an outer protrusion.

1. Folding method for folding a flap arrangement of a capsule;
wherein said capsule includes: a cup body defined by a side wall and by an end wall that bounds, at one end, said side wall; a tamper-evident band connected to said side wall by connecting elements and having an edge from which said flap arrangement leads; and an outer protrusion extending laterally outside said capsule;
said folding method including the steps of:
arranging said capsule resting on a support element of a folding apparatus with one end facing upwards;
moving a punch element of said folding apparatus along a centring direction towards said support element and inserting said punch element inside said cup body until a centring element of said punch element interacts with clearance, in particular a radial clearance <0.30 mm, with inner portions of said capsule so as to block, or limit, a movement of said capsule along a plane perpendicular to said centring direction;
moving said support element along an operating direction having at least one component parallel to and opposite said centring direction, said moving said support element along said operating direction including dragging said capsule and said punch element along said operating direction;
during said moving said support element along said operating direction, making said flap arrangement interact with an abutting arrangement of said folding apparatus to rotate said flap arrangement from an initial configuration extending outwardly said cup body to an end configuration folded inwardly said cup body;
in which, when said centring element interacts with said inner portions of said capsule, a main axis of said capsule and a longitudinal axis of said abutting arrangement coincide so that said support element takes said capsule to interact with said abutting arrangement in a centred position with respect to said abutting arrangement wherein said outer protrusion remains spaced apart from said abutting arrangement.

2. Method according to claim 1, wherein said clearance includes a radial clearance <0.15 mm, in particular <0.05 mm.

3. Method according to claim 1, wherein said inserting said punch element inside said cup body includes moving said capsule laterally by said centring element so as to make said main axis coincide with said longitudinal axis.

4. Method according to claim 1, wherein said moving said support element along said operating direction includes:
carrying said flap arrangement to interact with at least one portion of tilted surface of an abutting surface of a first abutting element of said abutting arrangement, said at least one portion of tilted surface being shaped to cooperate with said flap arrangement to permit a first partial rotation of said flap arrangement from said initial configuration extending outwardly to an intermediate configuration in which said flap arrangement is rotated partially towards said main axis of said capsule; and, subsequently,
taking a portion of said edge of said tamper-evident band to abut on a step portion of said abutting surface.

5. Method according to claim 4, wherein, after said taking a portion of said edge of said tamper-evident band to abut on said step portion said support element there is provided continuing moving along said operating direction and pushing said edge onto said step portion to move said first abutting element along a direction having a component parallel to and concordant with said operating direction.

6. Method according to claim 5, wherein said continuing moving said support element along said operating direction includes inducing said flap arrangement to interact progressively with a plurality of parts of a further abutting surface of a second abutting element of said abutting arrangement, said further abutting surface being shaped to cooperate with said flap arrangement to take said flap arrangement from said intermediate configuration to said end configuration folded inwardly in which said flap arrangement is folded inside said tamper-evident band.

7. Method according to claim 6, and further including, after obtaining said end configuration folded inwardly, moving again said punch element along said centring direction to move said capsule away from said abutting arrangement, wherein during said moving again said punch element along said centring direction, there is provided simultaneously moving said support element along a direction having at least one component parallel to and concordant with said centring direction, said moving again said punch element along said centring direction including pushing said capsule to abut on a rest surface of said support element.

8. (canceled)

9. Method according to claim 1, wherein said inserting said punch element inside said cup body includes inducing a circumferential perimeter area of said centring element to interact with inner portions of a seal element of said capsule so as to block, or limit, a movement of said capsule along a plane perpendicular to said centring direction or wherein said inserting said punch element inside said cup body includes inducing a circumferential perimeter area of said centring element to interact with inner portions of a first annular portion of said capsule so as to block, or limit, a movement of said capsule along a plane perpendicular to said centring direction or wherein said inserting said punch element inside said cup body includes inducing a circumferential perimeter area of said centring element to interact with inner portions of an inner thread of said capsule so as to block, or limit, a movement of said capsule along a plane perpendicular to said centring direction.

10. (canceled)

11. (canceled)

12. Folding apparatus for folding a flap arrangement of a capsule, wherein said capsule includes: a cup body defined by a side wall and by an end wall that bounds, at one end, said side wall; a tamper-evident band connected to said side wall by connecting elements and having an edge from which said flap arrangement leads; and an outer protrusion extending laterally outside said capsule; said folding apparatus including:
a support element arranged for restingly receiving and supporting said capsule with one end facing upwards, said support element being movable along an operating direction;
a punch element configured to be inserted inside said cup body and movable along a centring direction having at least one component parallel to and opposite said operating direction, said punch element being provided with a centring element arranged for interacting with clearance, in particular a radial clearance <0.30 mm or <0.15 mm or <0.05 mm, with inner portions of said capsule when said punch element is inserted inside said cup body so as to block, or limit, a movement of said capsule along a plane perpendicular to said centring direction;
an abutting arrangement configured to interact with said flap arrangement to rotate said flap arrangement from an initial configuration extending outwardly said cup body to an end configuration folded inwardly said cup body;
in which, when said centring element interacts with said inner portions of said capsule, a main axis of said capsule and a longitudinal axis of said abutting arrangement coincide so that said support element can drag said capsule along said operating direction in a centred position of said capsule with respect to said abutting arrangement wherein said outer protrusion remains spaced apart from said abutting arrangement.

13. Apparatus according to claim 9, wherein said punch element is further provided with a stem that is coaxial with said longitudinal axis, said centring element being fitted to said stem at one end of said stem or at a set distance from a free end of said stem intended to come into axial contact with said capsule, said centring element and said stem being, in particular, formed as a single body and/or wherein said centring element is substantially shaped in the form of a disc.

14. (canceled)

15. Apparatus according to claim 9, wherein said abutting arrangement includes a first abutting element and a second abutting element configured to interact with said flap arrangement and cause a rotation thereof around a deformable zone of said capsule, said first abutting element and said second abutting element being movable axially with relative motion of the ones in relation to the others.

16. Apparatus according to claim 11, wherein said first abutting element is movable axially along a direction having a component parallel to and concordant with said operating direction and said second abutting element are fixed.

17. Apparatus according to claim 9, wherein said first abutting element includes an outer sleeve including an abutting surface arranged for abutting on said flap arrangement, said abutting surface including at least one portion of tilted surface shaped to cooperate with said flap arrangement to permit a first partial rotation of said flap arrangement from said initial configuration extending outwardly to an intermediate configuration in which said flap arrangement is rotated partially towards said main axis of said capsule.

18. Apparatus according to claim 13, wherein said abutting surface further includes a step portion shaped to receive abuttingly a portion of said edge of said tamper-evident band.

19. Apparatus according to claim 14, wherein said step portion is interposed between two tilted surface portions, each of said tilted surface portions connecting a part of said step portion with an outer face of said outer sleeve and cooperating to rotate said flap arrangement in said intermediate configuration.

20. Apparatus according to claim 8, wherein said second abutting element includes an inner sleeve that is coaxial with said outer sleeve and arranged nearer said longitudinal axis with respect to said outer sleeve, said inner sleeve being provided with a further abutting surface arranged for further abutting on said flap arrangement and shaped to cooperate with said flap arrangement to permit a further rotation of said flap arrangement from said intermediate configuration to said end configuration folded inwardly.

21. Apparatus according to claim 16, wherein said further abutting surface includes a re-entrant curve portion shaped to facilitate the progressive rotation of said flap arrangement from said intermediate configuration to said end configuration folded inwardly.

22. Apparatus according to claim 15, wherein said abutting arrangement further includes an elastic arrangement associated with said first abutting element to urge constantly said first abutting element to a rest position.

23. Use of a folding apparatus according to claim 9 to implement a folding method for folding a flap arrangement of a capsule according to claim 1.

24. Combination of a capsule and of a folding apparatus for folding a flap arrangement of said capsule, said capsule further including:
a cup body defined by a side wall and by an end wall that bounds, at one end, said side wall;
a tamper-evident band connected to said side wall by connecting elements and having an edge from which said flap arrangement leads; and
an outer protrusion extending laterally outside said capsule;
said folding apparatus including:
a support element arranged for restingly receiving and supporting said capsule with one end facing upwards, said support element being movable along an operating direction;
a punch element configured to be inserted inside said cup body and movable along a centring direction having at least one component parallel to and opposite said operating direction, said punch element being provided with a centring element arranged for interacting with clearance, in particular a radial clearance <0.30 mm or <0.15 mm or <0.05 mm, with inner portions of said capsule when said punch element is inserted inside said cup body so as to block, or limit, a movement of said capsule along a plane perpendicular to said centring direction; and
an abutting arrangement configured to interact with said flap arrangement to rotate said flap arrangement from an initial configuration extending outwardly said cup body to an end configuration folded inwardly said cup body;
in which, when said centring element interacts with said inner portions of said capsule, a main axis of said capsule and a longitudinal axis of said abutting arrangement coincide so that said support element can drag said capsule along said operating direction in a centred position of said capsule with respect to said abutting arrangement wherein said outer protrusion remains spaced apart from said abutting arrangement.
